(19) United States
(12) Patent Application Publication
(10) Pub. No.: US 2024/0286892 A1
(43) Pub. Date: Aug. 29, 2024

(54) Methods and Systems for Enhancing Absorption and Desorption of Hydrogen by a Metal Hydride Composite Material

(71) Applicant: CHEVRON U.S.A. INC., San Ramon, CA (US)

(72) Inventors: William BOORUJY, Livermore, CA (US); Karen DIDOMENICIS, Martinez, CA (US)

(21) Appl. No.: 18/584,975

(22) Filed: Feb. 22, 2024

Related U.S. Application Data
(60) Provisional application No. 63/447,916, filed on Feb. 24, 2023.

(51) Int. Cl. C01B 3/00; F17C 11/00

(52) U.S. Cl. CPC C01B 3/001; F17C 11/005; F17C 2221/012; F17C 2227/03

(57) ABSTRACT

Processes and systems are provided to enhance the rates of absorption and desorption of hydrogen into and out of a metal hydride composite material as part of a system for storing and/or compressing hydrogen. The rates of absorption and desorption are enhanced by techniques that enhance heat transfer between metal hydride composite material and a heat exchanger. Embodiments include the use of thermally conductive adhesive, grease or solder between the metal hydride composite material and heat exchanger element, snugly wrapping the metal hydride-heat exchanger element assembly with an expanded metal sheath or a flexible wire, and combinations thereof.

### FIELD

This disclosure relates generally to methods and systems to enhance the rates of absorption and desorption of hydrogen by a metal hydride material, specifically by enhancing heat transfer between a metal hydride composite material and a heat exchange element.

### BACKGROUND

Metal hydrides are solid materials known for their ability to absorb and desorb gaseous hydrogen in response to the removal or addition of heat to the metal hydride, respectively. Much effort has been undertaken to improve the thermal conductivity of metal hydrides and improve methods to transfer heat to metal hydrides. See, for example, M. Afzal et al. (“Heat transfer techniques in metal hydride hydrogen storage: A review”, Int. J. Hydrogen Energy 2017, 42, 30661-30682). In one area of research, metal hydrides are employed in hydrogen compression. One challenge with this is ensuring that heating and cooling of the metal hydride can occur quickly. Various techniques have been attempted to transfer heat and cooling more quickly from a heat transfer fluid in a heat exchanger to a metal hydride, including imbedding metal foam, particles, or graphite in the metal hydride material.

Despite the efforts to date, there remains a need for faster and more scalable methods and systems for storing and releasing hydrogen utilizing metal hydrides.

### SUMMARY

Provided are processes and systems to enhance the rate of heat transfer between a heat exchanger element such as, but not limited to, a tube in a shell-and-tube heat exchanger, and an adjacent metal hydride composite material. The systems can be part of a metal hydride-based system for the storage and/or compression of hydrogen. The processes and systems advantageously increase the thermal contact conductance between the heat exchanger element and the metal hydride.

Systems disclosed herein further provide the advantage of being more easily mass produced and therefore more cost effective than previous solutions.

### BRIEF DESCRIPTION OF THE DRAWINGS

FIG. 1 shows an assembly for facilitating the absorption and desorption of hydrogen in a metal hydride composite material according to one embodiment.

FIG. 2 shows an assembly for facilitating the absorption and desorption of hydrogen in a metal hydride composite material according to another embodiment.

FIG. 3 shows an assembly for facilitating the absorption and desorption of hydrogen in a metal hydride composite material according to another embodiment.

### DESCRIPTION

Turning to the Drawings, various embodiments are illustrated, but are not meant to be limiting. It is understood the units, components indicated by the same number in different figures are meant to indicate the same components.

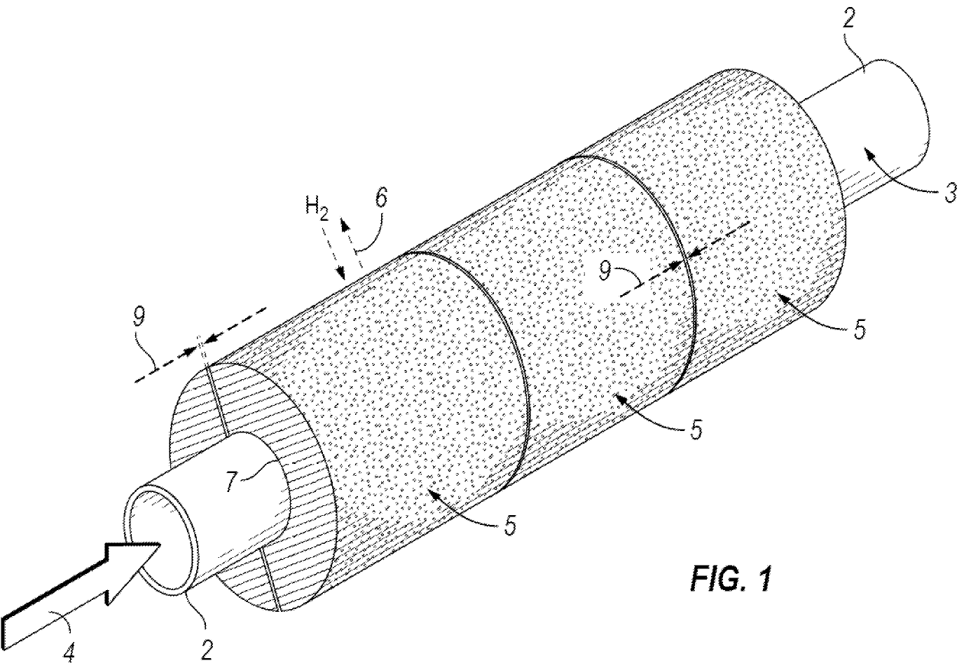

According to one embodiment, referring to FIG. 1, a heat exchanger element 2 of a heat exchanger is adapted to contain a heat exchange fluid therein 4 and has an outer surface 3. As would be understood to one of ordinary skill in the art, the heat exchanger element 2 can be any suitable form of element in a heat exchanger. In one embodiment the element 2 is a tube in a shell-and-tube heat exchanger. The heat exchange fluid therein 4 can be water at various temperatures, ranging from cooling water to steam, e.g., 150-pound steam at 360-375° F. In one embodiment, the heat exchanger can be operated at a hydrogen absorption temperature, e.g., 75-80° F. to store hydrogen in the metal hydride. In one embodiment, the heat exchanger can be operated to cycle between at least a hydrogen absorption temperature, e.g., 75-80° F., and a hydrogen desorption temperature e.g., 360-375° F., to effect alternating absorption and desorption of hydrogen 6 by a metal hydride composite material 5.

The metal hydride composite material 5 is secured to the outer surface 3 of the element 2 such that the metal hydride composite material 5 contacts the outer surface 3. The metal hydride composite material 5 can be secured in multiple pieces configured to contact the outer surface 3. The multiple pieces can be between about ¼ and about 2 inches thick, even between about ½ and about 1 inch thick. The multiple pieces can be semi-toroidal (rectangular-toroidal) shaped as in FIG. 1 or the metal hydride composite material 5 can be divided into more than two pieces that together fit around the element 2 such that they contact the outer surface 3. The pieces can also vary in axial length. Both axially and radially, a small gap 9 can be provided between the pieces to allow for expansion and contraction due to thermal stress and hydrogen absorption and desorption. The gap 9 can be, for example, up to 18 inch.

By “metal hydride” is meant a compound having a metal bonded to hydrogen. The term “metal hydride composite” herein includes composites of metal hydride material combined with other materials to provide improved heat transfer and strength, such as carbon or a metal such as aluminum or copper. The composite material can be fused together either through sintering, pressure, or other methods. The resulting material has sufficient porosity to allow for the exchange of hydrogen gas throughout. The resulting composite material can be formed into a solid block of various shapes. Suitable metal hydrides have interstitial sites therein capable of storing hydrogen. When used in a hydrogen compression system, the tunable thermodynamic properties are leveraged, i.e., a temperature dependence of the absorption and desorption pressure that would provide a desired hydrogen compression ratio in a reasonable temperature range. This can include, but is not limited to, AB5-type intermetallics, AB2-type intermetallics, vanadium-based BCC solid solution alloys, TiFe-based AB-type intermetallics, and combinations thereof. The selection of metal hydride used in the metal hydride composite material 5 will depend on pressure ranges required. For some compression applications multi-stage compression may be needed, and different metal hydrides may be selected for each stage. In addition to the thermodynamic properties to meet the compression needs, other criteria for metal hydride selection can include high reversible hydrogen storage capacity, fast kinetics of hydrogen absorption/desorption, slow degradation, and low cost.

In one embodiment, the metal hydride composite is secured to the outer surface of the element by a thermally conductive layer 7 between the metal hydride composite material 5 and the at least one element 2. By “thermally conductive” is meant having a thermal conductivity of greater than about 0.3 W/m-K and can be up to about 60 W/m-K or more. In one embodiment, the thermally conductive layer is a thermally conductive adhesive layer. The thermally conductive adhesive can be is applied to the outer surface 3 of the element 2 either as bulk adhesive or in the form of an adhesive tape. Bulk adhesive can be applied by brush, roller, or other suitable applicator. After the application of the adhesive layer, the pieces of metal hydride composite material 5 are positioned in contact with the adhesive to secure the metal hydride composite material 5 to the element 2.

The thermally conductive adhesive can be any thermally conductive adhesive or epoxy capable of maintaining adhesion, once in place and cured if required, at temperatures between the hydrogen absorption and desorption temperatures of the metal hydride selected. The adhesive can include, but is not limited to, thermally conductive adhesives available from Panacol (Hessen, Germany) under the tradename Elecolit®, from DELO Industrial Adhesives (Windach, Germany) under the tradename DELO MONOPOX TC2270, from Henkel (Disseldorf, (Gerrnany) under the tradename Bergquist Liqui Bond TLB SA3500, and from Master Bond Inc. (Hackensack, NJ) under the tradename EP3HTS-TC.

In another embodiment, the thermally conductive layer 7 is a layer of thermally conductive solder. Solder is well-known as a fusible metal alloy that is melted and then solidified to join two objects. In some embodiments, the thermally conductive solder can be applied to the outer surface 3 of the element 2 in the form of a wire, ribbon, sheet, or a solder paste. After the application of the solder on the outer surface of the element, the pieces of metal hydride composite material 5 are positioned in contact with the solder and then heat is applied to the assembly to reach the melting temperature of the solder. The heat may be applied by heating the assembly in an oven to the melting temperature of the solder. Alternatively, the element 2 can be heated by heating the element 2 by any suitable method including, for example, conduction or induction heating to bring the solder to the melting temperature of the solder. The molten solder fills in the space between the pieces of metal hydride composite material 5 and the element 2. The solder then cools to solidify and bond the metal hydride composite material 5 to the element 2.

The thermally conductive solder used can be any solder capable of conducting heat and maintaining adhesion (once set) at temperatures between the hydrogen absorption and desorption temperatures of the metal hydride composite selected. The melting temperature of the solder is greater than the hydrogen desorption temperature when the system will be used for absorption and desorption of hydrogen from the metal hydride. Such solder types include, but are not limited to, alloys containing gold, silver, tin and/or copper, tin having a melting temperature of 232° C., 99C having a melting temperature of 227° C. and a thermal conductivity of 40 W/m-K, 97C having a melting temperature of 230-250° C., SAC3 having a melting temperature of 217-219° C. and a thermal conductivity of 60 W/m-K, and MCi having a melting temperature of 232° C.

The thermally conductive layer, after setting or curing as required, is as thin as necessary to bond the pieces of metal hydride composite material 5 to the element 2 and preferably not thicker. The needed thickness will vary depending on the metal hydride composite and the thermal stresses given the temperatures and pressures used. The thermally conductive layer can be, for example, up to 1%8 inch thick.

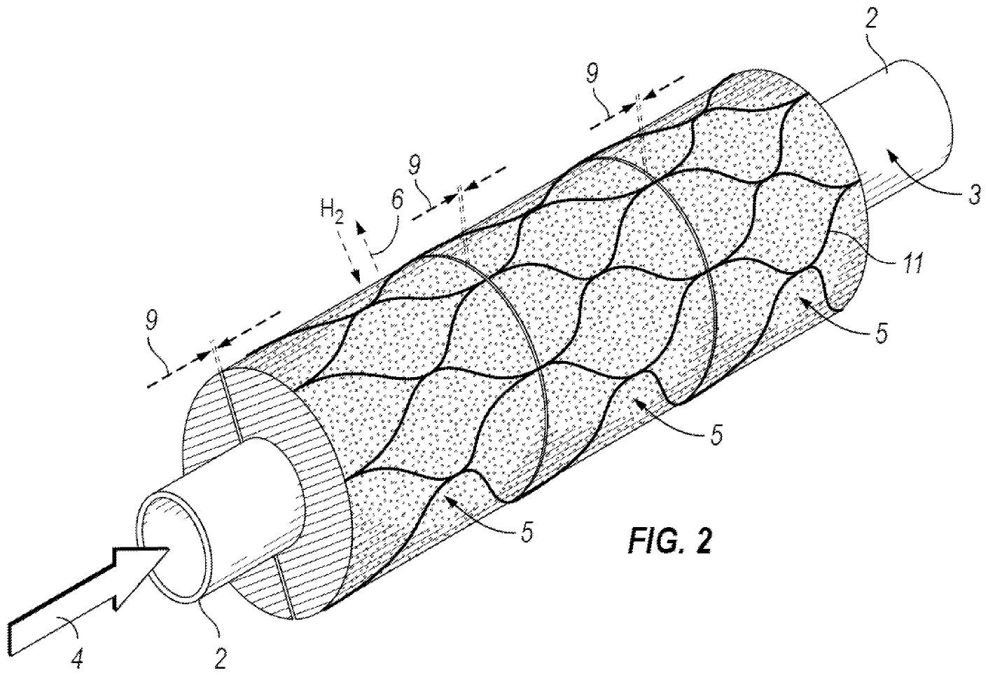

In another embodiment, shown in FIG. 2, the metal hydride composite material 5 is secured to the element 2 by a sheath of expanded metal or wire mesh netting (shown) 11 placed over the metal hydride composite material 5 such that the sheath surrounds the metal hydride composite and holds it securely in place in direct contact with the element 2. In one embodiment, the thermally conductive layer 7 can be a thermally conductive paste or grease. The thermally conductive paste or grease can include, but is not limited to, thermally conductive grease available from Aremco Products, Inc., (Valley Cottage, NY), e.g., under the tradename Heat-Away 641, and from Holland Shielding Systems BV (Dordrecht, The Netherlands) sold as Silver-Filled Conductive Silicone Grease. In one embodiment, the sheath 11 is formed of a metal selected from copper, aluminum, stainless steel, or titanium alloys. Expanded metal is typically formed by slitting and stretching metal sheet to create diamond shaped openings. In one embodiment, a sheath of expanded metal 11 is preformed into a cylindrical shape and positioned snugly around the hydride material 5, optionally using a cone to facilitate stretching and installing the sheath over the hydride material. Alternatively, the sheath of expanded metal 11 is a flat sheet that is wrapped around the hydride material 5, and secured using any suitable attachment, e.g., ties, connectors, springs, and the like to hold the sheet snugly in place. The expanded metal can be formed of copper, aluminum, stainless steel, or titanium alloys. The sheath 11 can be formed from a wire mesh netting material. Wire mesh netting is typically formed by placing strands of wire rope parallel to each other and connecting adjacent wire ropes with clamps or other connectors.

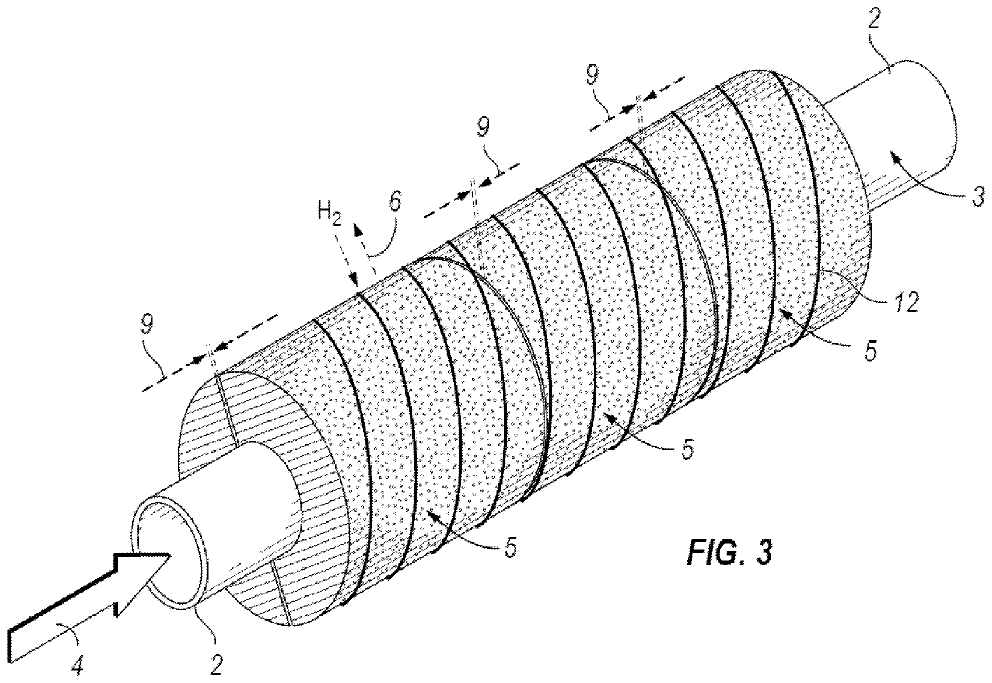

In another embodiment, shown in FIG. 3, the metal hydride composite material 5 is secured to the element 2 by a flexible wire 12 wrapped around the metal hydride composite material 5 such that it holds it securely in place in direct contact with the element 2. In one embodiment, the flexible wire 12 is formed of a metal selected from copper, aluminum, stainless steel, or titanium alloys.

Different embodiments can be combined to provide additional durability. For instance, the metal web netting 11 and/or the flexible wire 12 as shown in FIGS. 2 and 3 can be placed over the metal hydride composite material 5 which in turn is adhered to the element 2 using a thermally conductive layer 7 as shown in FIG. 1.

The above-described embodiments are meant to illustrate and not to limit the invention, and other process schemes within the scope of the invention may be envisioned.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present process and system, but they are not essential to its practice. It is therefore to be understood that the invention may be practiced otherwise than as specifically described without actually departing from the spirit and scope of the present invention as defined by the appended claims.

What is claimed is:

1. A process for absorbing and desorbing hydrogen into and from a metal hydride material comprising:
(a) providing a heat exchanger comprising at least one element containing heat exchange fluid therein and having an outer surface;
(b) securing multiple pieces of a metal hydride composite material to the outer surface of the at least one element; and
(c) operating the heat exchanger to cycle between at least a hydrogen absorption temperature and a hydrogen desorption temperature to effect alternating absorption and desorption of hydrogen by the metal hydride material.

2. The process of claim 1, wherein the multiple pieces of metal hydride composite material are secured to the outer surface of the at least one element by a thermally conductive layer between the multiple pieces of metal hydride composite material and the at least one element.

3. The process of claim 2, wherein the thermally conductive layer comprises a thermally conductive adhesive.

4. The process of claim 3, wherein the thermally conductive adhesive is applied to the outer surface of the at least one element in the form of a thermally conductive adhesive tape, and wherein subsequent to the application of the adhesive tape, the multiple pieces of metal hydride composite material are positioned in contact with the adhesive tape to secure the multiple pieces of metal hydride composite material to the outer surface of the at least one element.

5. The process of claim 2, wherein the thermally conductive layer comprises a thermally conductive solder.

6. The process of claim 5, wherein the thermally conductive solder is applied to the outer surface of the at least one element in the form of a solder paste.

7. The process of claim 6 wherein subsequent to the application of the solder paste, the multiple pieces of metal hydride composite material are positioned in contact with the solder paste and heat is applied to secure the multiple pieces of metal hydride composite material to the outer surface of the at least one element.

8. The process of claim 1, wherein the multiple pieces of metal hydride composite material are secured to the at least one element by a sheath of expanded metal or wire mesh netting surrounding the multiple pieces of metal hydride composite material.

9. The process of claim 1, wherein the multiple pieces of metal hydride composite material are secured to the at least one element by a flexible wire wrapped around the multiple pieces of metal hydride composite material.

10. The process of claim 8 or claim 9, wherein between the metal hydride composite and at least one element is a layer of thermally conductive grease.

11. A system for absorbing and desorbing hydrogen into and from a metal hydride material comprising:
(d) a heat exchanger comprising at least one element containing heat exchange fluid therein and having an outer surface;
(e) multiple pieces of metal hydride composite material secured to the outer surface of the at least one element; and
(f) a controller to operate the heat exchanger to cycle between at least a hydrogen absorption temperature and a hydrogen desorption temperature to effect alternating absorption and desorption of hydrogen by the multiple pieces of metal hydride composite material.

12. The system of claim 11, further comprising a thermally conductive layer between the multiple pieces of metal hydride composite material and the at least one element for securing the multiple pieces of metal hydride composite material to the outer surface of the at least one element.

13. The system of claim 12 wherein the thermally conductive layer comprises a thermally conductive adhesive.

14. The system of claim 12, wherein the thermally conductive layer comprises a thermally conductive solder.

15. The system of claim 11, further comprising a sheath of expanded metal or wire mesh netting surrounding the multiple pieces of metal hydride composite material.

16. The system of claim 11, further comprising a flexible wire wrapped around the multiple pieces of metal hydride composite material.

17. The system of claim 15 or claim 16, wherein between the metal hydride composite and the at least one element is a layer of thermally conductive grease.
